(19) United States
(12) Patent Application Publication
(10) Pub. No.: US 2023/0408377 A1
(43) Pub. Date: Dec. 21, 2023

(54) Systems and Methods for Plant Sample Collection and Extraction

(71) Applicant: Curated Leaf Services LLC dba PhenoXpress, Saugus, MA (US)

(72) Inventors: Wendell Orphe, Saugus, MA (US); Steve Gordon, Saugus, MA (US)

(73) Assignee: Curated Leaf Services LLC dba PhenoXpress, Saugus, MA (US)

(21) Appl. No.: 18/210,892

(22) Filed: Jun. 16, 2023

Related U.S. Application Data
(60) Provisional application No. 63/353,458, filed on Jun. 17, 2022.
(60) Provisional application No. 63/396,860, filed on Aug. 10, 2022.

(51) Int. Cl. G01N 1/08

(52) U.S. Cl. CPC G01N 1/08

(57) ABSTRACT

The present disclosure is directed to implementations of systems and methods for plant tissue sampling utilizing a sampling clip. The clip may be used to obtain a tissue sample of a plant and retain the sample for subsequent analysis. The clip, including the sample, may be shipped (if necessary) without the user ever needing to contact the sample directly. In many implementations, the sample may be automatically extracted from the clip for analysis without requiring human intervention. As a result, cross-contamination possibilities may be avoided or eliminated. The clip and/or sample collectors may be disposed of after use or sterilized in a group.

### RELATED APPLICATIONS

This application claims the benefit of and priority to U.S. Provisional Application No. 63/353,458, entitled “Systems and Methods for Plant Sample Collection,” filed Jun. 17, 2022; and U.S. Provisional Application No. 63/396,860, entitled “Systems and Methods for Automated Sample Extraction,” filed Aug. 10, 2022, the entirety of each of which are incorporated herein by reference.

### FIELD

The present disclosure is directed to systems and methods for plant sample collection. In particular, the present disclosure is directed to implementations of tools to collect tissue samples of plants for subsequent biological analysis.

### BACKGROUND

Tissue samples of plant matter (e.g., leaves, stems, flowers, or other portions) may be obtained for genetic and/or phenotypic testing or other agricultural purposes. However, typical sample collection methods may be prone to contamination by the user or may be difficult or slow to use. For example, cutting a small portion of a leaf of a plant with shears or scissors may result in cross-contamination with a prior or subsequent plant if the tool is not properly sterilized; and the user may need to grab the sample with tweezers to avoid touching the sample directly (similarly requiring the tweezers to be sterilized to avoid cross-contamination). The banning of decontamination methods that utilize bleach can create additional difficulties for a large grow facility that may need to sample a large number of plants.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, or structurally similar elements.

FIG. 1A is a perspective view of an implementation of a plant tissue sampler;

FIG. 1B is a reverse perspective view of the implementation of a plant tissue sampler of FIG. 1A;

FIGS. 1C-1E are front, side, and rear plan views, respectively, of the implementation of a plant tissue sampler of FIG. 1A;

FIG. 1F is a top plan view of the implementation of a plant tissue sampler of FIG. 1A;

FIG. 2A is a perspective view of a portion of a plant tissue sampler, according to some implementations;

FIG. 2B is a perspective view of another portion of a plant tissue sampler, according to some implementations;

FIG. 2C is a bottom plan view of the implementation of the portion of a plant tissue sampler of FIG. 2B;

FIGS. 3A and 3B are cross-sectional side and perspective views of an implementation of a plant tissue sampler;

FIGS. 4A-4C are side, top, and bottom views, respectively, of an implementation of a sample collector;

FIG. 4D is a cross-sectional view of the implementation of a sample collector of FIGS. 4A-4C;

FIG. 5A is a front perspective view of an implementation of an automated sample extractor;

FIG. 5A is a front perspective view of an implementation of an automated sample extractor;

FIG. 5B is a rear perspective view of an implementation of an automated sample extractor;

FIGS. 5C and 5D are front perspective views of an implementation of an automated sample extractor in a first mode and a second mode;

FIG. 6A is a perspective view of a portion of a plant tissue sampler, according to some implementations;

FIG. 6B is a perspective view of another portion of a plant tissue sampler, according to some implementations;

FIGS. 6C-6E are side, rear, and front plan views of the portion of a plant tissue sampler of FIG. 6A, according to some implementations;

FIGS. 6F and 6G are top and bottom plan views of the portion of a plant tissue sampler of FIG. 6A, according to some implementations;

FIGS. 6H-6I are side, rear, and front plan views of the portion of a plant tissue sampler of FIG. 6B, according to some implementations;

FIGS. 6K and 6L are top and bottom plan views of the portion of a plant tissue sampler of FIG. 6B, according to some implementations;

FIG. 6M is a reverse perspective view of the portion of a plant tissue sampler of FIG. 6A, according to some implementations;

FIG. 6N is a reverse perspective view of the portion of a plant tissue sampler of FIG. 6B, according to some implementations;

FIG. 7A is a front plan view of the plant tissue sampler of FIG. 6A illustrating extraction of a sample with a probe, according to some implementations;

FIG. 7B is a sequence of illustrations showing a portion of the plant tissue sampler of FIG. 7A during extraction of a sample, according to some implementations;

FIG. 8 is another perspective view of the plant tissue sampler of FIG. 6A, illustrating sealing of the containment chamber, according to some implementations; and

FIG. 9 is a perspective view of a hand tool for extraction of a sample with a probe, according to some implementations.

### DETAILED DESCRIPTION

Tissue samples of plant matter (e.g., leaves, stems, flowers, or other portions) may be obtained for genetic and/or phenotypic testing or other agricultural purposes. However, typical sample collection methods may be prone to contamination by the user or may be difficult or slow to use. For example, cutting a small portion of a leaf of a plant with shears or scissors may result in cross-contamination with a prior or subsequent plant if the tool is not properly sterilized; and the user may need to grab the sample with tweezers to avoid touching the sample directly (similarly requiring the tweezers to be sterilized to avoid cross-contamination). The banning of decontamination methods that utilize bleach can create additional difficulties for a large grow facility that may need to sample a large number of plants.

The present disclosure is directed to implementations of systems and methods for plant tissue sampling utilizing a sampling clip. The clip may be used to obtain a tissue sample of a plant and retain the sample for subsequent analysis. The clip, including the sample, may be shipped (if necessary) without the user ever needing to contact the sample directly. In many implementations, the sample may be automatically extracted from the clip for analysis without requiring human intervention. As a result, cross-contamination possibilities may be avoided or eliminated. The clip and/or sample collectors may be disposed of after use or sterilized in a group.

The clip may be constructed of inexpensive materials, such as injection molded plastics, 3D printed thermoplastics, cast metals such as aluminum, or any other such materials or combinations of materials. Samples obtained by the clips may be substantially uniform, avoiding user error and allowing for faster and more reliable analysis.

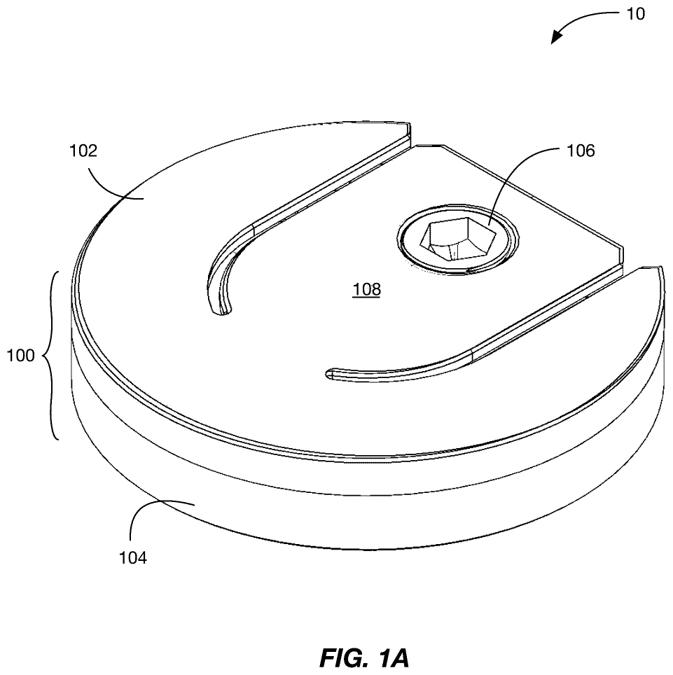

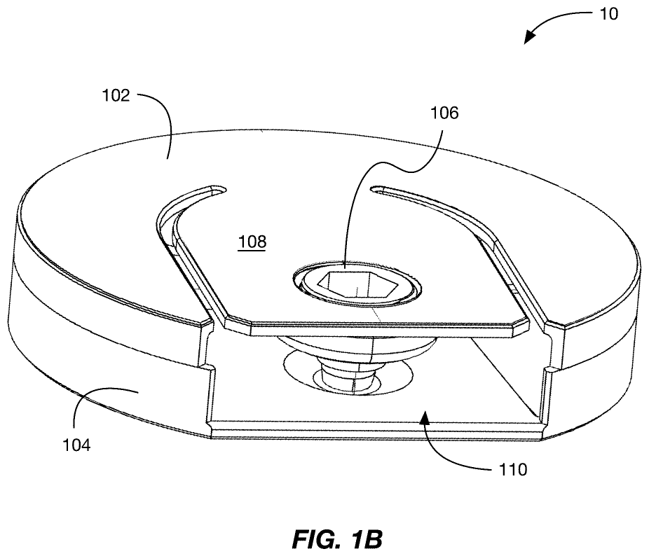

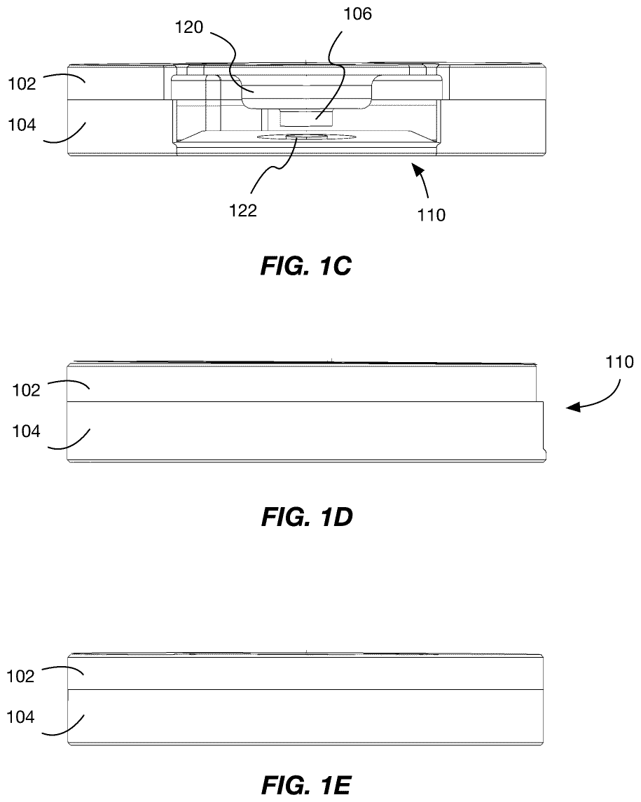

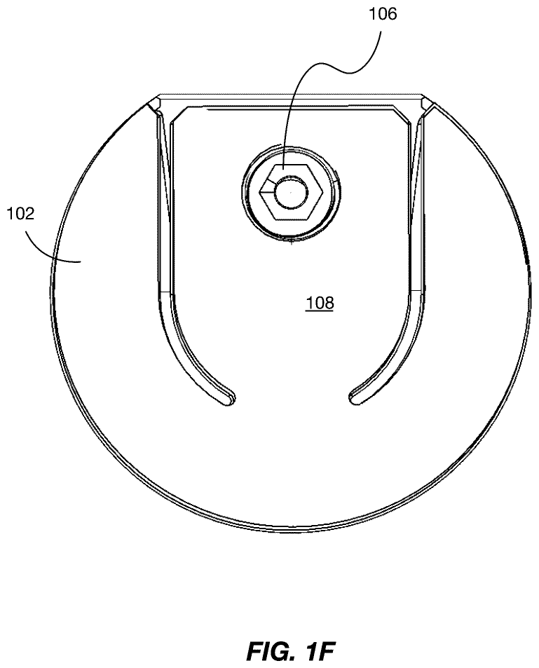

FIG. 1A is a perspective view of an implementation of a plant tissue sampler 10. The sampler 10, which may be referred to as a sample clip, sample punch, biopsy punch, or by other similar terms, may comprise a body 100 and collector 106. In many implementations, body 100 may be a unitary body (i.e. formed as a single unit, e.g., via injection molding, 3D printing, or other manufacturing process) or may be formed of separate body portions such as a top portion 102 and bottom portion 104. Body 100 may include a depressible region 108, which may be flexibly joined to a remainder of the body and/or top portion 102 via a hinge or similar joint (e.g., with one rotational degree of freedom). For example, in the implementation illustrated, depressible region 108 is joined with a remainder of top portion 102 via a flexible segment and separated by two grooves or channels, such that depressible region 108 may be pressed downwards towards bottom portion 104 of the body 100. The body 100 may be formed of a resilient material in many implementations, such that after depression, the depressible region 108 returns or approximately returns to a starting position approximately flush with the remainder of the top portion. This may avoid requiring an internal spring or other mechanism to provide a retraction or returning force. In other implementations, a spring or such mechanism may be included.

FIG. 1B is a reverse perspective view of the implementation of a plant tissue sampler of FIG. 1A. As shown, collector 106 may extend through top portion 102 into an internal chamber 110 of the sampler 10. When depressible region 108 is depressed, the collector 106 may be brought into contact with the bottom portion 104 of the sampler 10.

FIGS. 1C-1E are front, side, and rear plan views, respectively, of the implementation of a plant tissue sampler 10 of FIG. 1A (in many implementations, the sampler is laterally symmetrical, and accordingly only one side view is shown). As shown in FIG. 1C, the collector 106 protrudes through a retainer 120 formed in top portion 102, and is positioned above a punch 122 formed in bottom portion 104. When depressible region 108 is not depressed, there is a gap between the collector 106 and punch 122. Plant tissue (e.g., a leaf) may be inserted into chamber 110 and into this gap between the collector 106 and punch 122. When the depressible region 108 is then depressed, collector 106 is pressed (along with the plant tissue) into punch 122. As punch 122 has a smaller outer diameter than an inner diameter of collector 106, the punch 122 slides into collector 106 and the edges of collector 106 sever the sampled tissue from the remainder of the plant body, thus punching out a circular tissue sample. The depressible region 108 may be undepressed and return to its starting position, and the plant tissue may be removed from the chamber. The sampled portion is retained within the collector 106 for subsequent extraction and analysis. In some implementations, multiple samples may be taken from a plant (e.g., punching samples from different leaves on the plant) and retained in the collector 106 simultaneously. This may improve reliability of the analysis by providing more tissue from different locations on the plant. Cross-contamination may still be avoided, provided the samples are all from the same plant.

FIG. 1F is a top plan view of the implementation of a plant tissue sampler of FIG. 1A. In some implementations, the collector 106 may have a top portion or socket with a profile allowing for torque to be applied to the collector. For example, in the implementation shown, the collector 106 includes a hexagonal socket. During analysis, a corresponding hexagonal driver may be inserted into the socket. The collector 106 may be threaded, such that it may be unscrewed from corresponding threads in the top portion 102 or retainer 120 of the top portion for removal. Other socket profiles or shapes may be utilized in various implementations (e.g., triangular, square, pentagonal, cross-shaped, multi-lobed, rectangular (i.e. a slot), or any other such shapes).

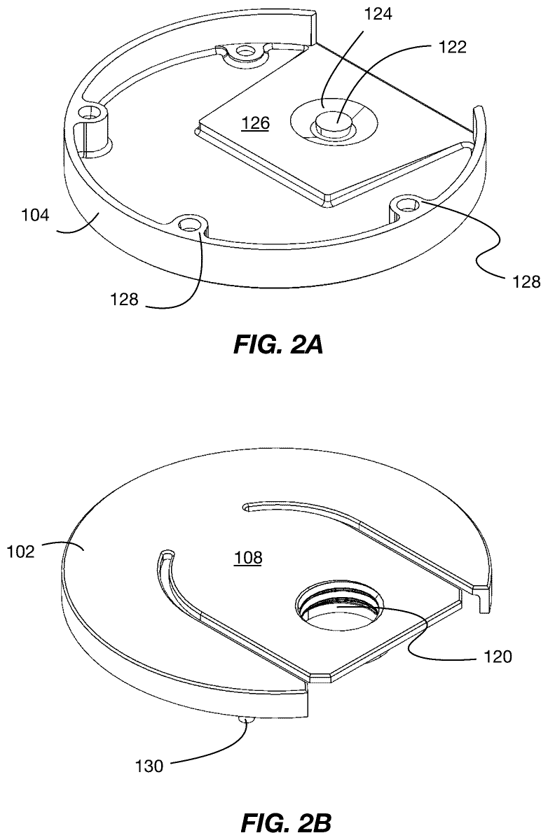

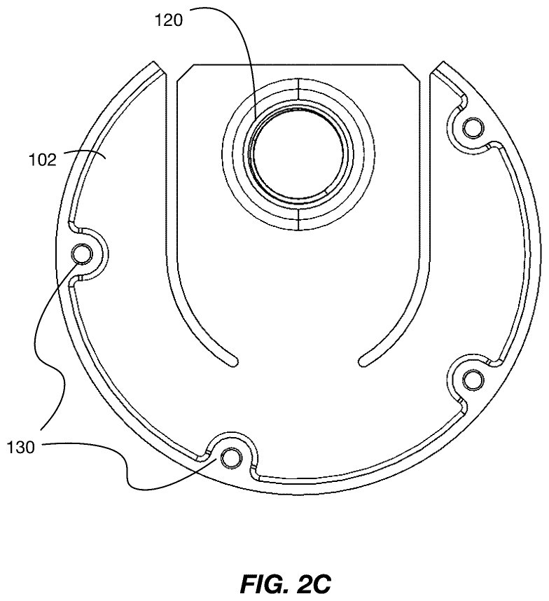

FIG. 2A is a perspective view of a bottom portion 104 of a plant tissue sampler, according to some implementations. A punch and die configuration is utilized to cut samples and contain them in the collector 106. As shown, an interior face (e.g., top face) of the bottom portion 104 may include a punch 122, which may comprise a circular, oval, square, triangular, star, or other shape protrusion corresponding to an identically shaped die, hole or channel in a collector 106, and sized to press a tissue sample into the collector (e.g., an outer diameter of the punch protrusion may be less than a corresponding inner diameter of the die channel in the collector). The punch 122 may have a flat profile in many implementations, or may be angled in others (e.g., with a sloped face and/or sloped sides). In some implementations, the punch 122 may be surrounded by a channel 124 to accommodate annular walls of the die in the collector 106 when a sample is being collected. Channel 124 may comprise an indentation in support surface 126, which may provide support for surrounding portions of plant tissue (e.g., a leaf) during sampling. In other implementations, support surface 126 and channel 124 may be absent.

In some embodiments, punch 122 and die elements have sufficiently close fit to limit the passage of gases between their peripheries, which may serve to better preserve the moisture content of a sample once cut.

FIG. 2B is a perspective view of a top portion 102 of a plant tissue sampler, according to some implementations. In the illustration of FIG. 2B, the collector 106 is absent. As shown, top portion 102 may include collector retainer 120, which may comprise a threaded channel or hole configured to receive the collector 106.

In some implementations in which the body 100 of the sampler is split into a top portion and bottom portion, each portion may have one or more features for fixing the portion to the opposing portion. For example, as shown in FIG. 2A, the bottom portion may comprise one or more holes 128 for matching to corresponding pegs 130 of a top portion, as shown in FIG. 2B. FIG. 2C is a bottom plan view of the implementation of the portion of a plant tissue sampler of FIG. 2B illustrating placement of pegs 130, according to one implementation. In the illustrated implementations of FIGS. 2A-2C, the holes and pegs are asymmetrically placed around the body. In other implementations, the holes and pegs may be symmetrically placed (e.g., mirrored across a line laterally through the centroid of the body and the punch 122 or retainer 120. Although shown as pegs and holes, in many implementations, other fixture elements may be utilized (e.g., clips, latches, dovetail joints, etc.). Similarly, although shown with pegs in top portion 102 and holes in bottom portion 104, in many implementations, these may be reversed and/or mixed (e.g., with each portion having holes and pegs). In other implementations in which body 100 is manufactured as a unitary body, no retaining structures may be needed. In some such implementations, additional strength structures may be included (e.g., pillars between each surface) to prevent compression of the non-depressible portion of the body.

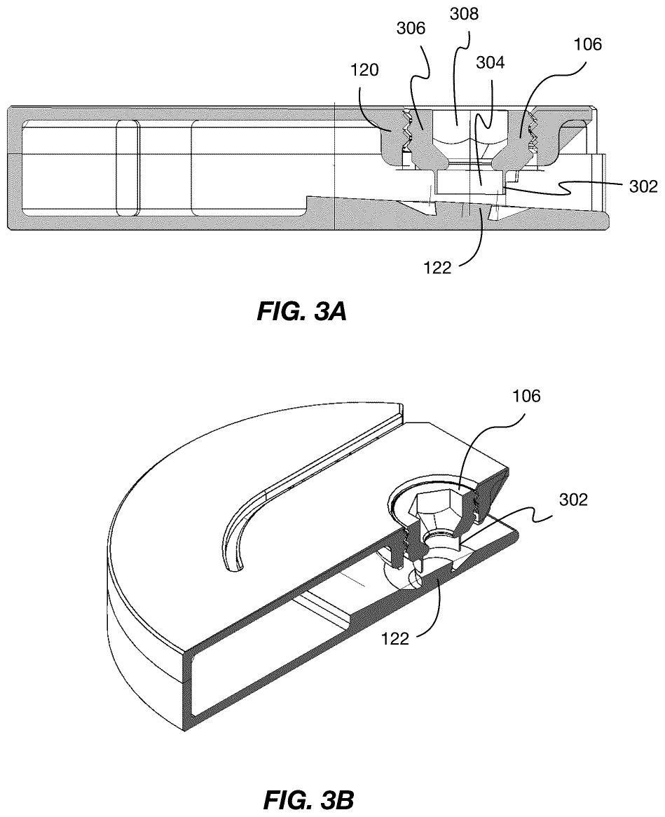

FIGS. 3A and 3B are cross-sectional side and perspective views of an implementation of a plant tissue sampler. As shown, collector 106 may include a lower portion or collection chamber 304 bounded by lower walls 302, and an upper portion or socket 308 bounded by upper walls 306. Upper walls 306 may include exterior threading, matched to threading on an interior surface of retainer 120, to allow the collector 106 to be removably retained in the sampler.

Punch 122 may be angled as shown in many implementations. As the depressible portion 108 of the sampler is depressed and pivots around its hinge, collector 106 will be rotated due to its distance from the pivot point. Punch 122 may be angled such that collector 106 is parallel to the top surface of the punch when the portion 108 is fully depressed. This may allow for more accurate and efficient sample collection. Additionally, when a plant tissue is placed between the collector and punch, the collector may not contact the tissue surface all at once, but rather may contact the tissue at a first point (e.g., closest to the hinge of depressible portion 108) first. As the portion is depressed further, the contact point(s) may move across the tissue surface until reaching a point furthest from the hinge. This allows the walls of the collector 302 to die, through the tissue sample progressively rather than all at once, which may reduce the force needed to take the sample, as well as reducing the possibility of tearing, crushing, or other damage to the tissue sample and/or sampler.

As discussed above, in many implementations, socket 308 may have a geometric profile to match to a driver (e.g., hexagonal, as shown, or other shapes). In some implementations, socket 308 may be threaded to receive a corresponding helical shaft (e.g., a bolt). In some implementations, socket 308 may have a thread with an opposite direction to a thread on an outer surface of upper walls 306 (e.g., a counterclockwise thread within socket 308 and a clockwise thread around the collector wall). This may allow for an extraction machine utilizing a corresponding helical shaft to automatically withdraw the collector without reversing direction: the shaft may be rotated and inserted into the socket and, once reaching the end of the socket, may continue to be rotated, causing the entire collector 106 to rotate and withdraw from the body 100.

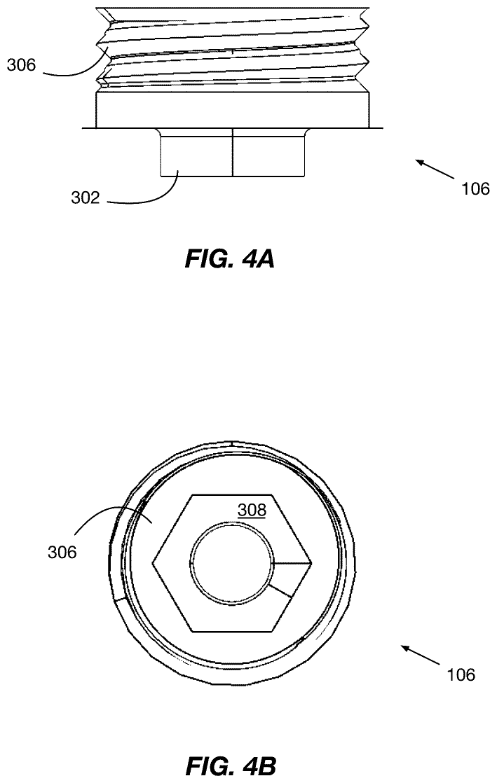

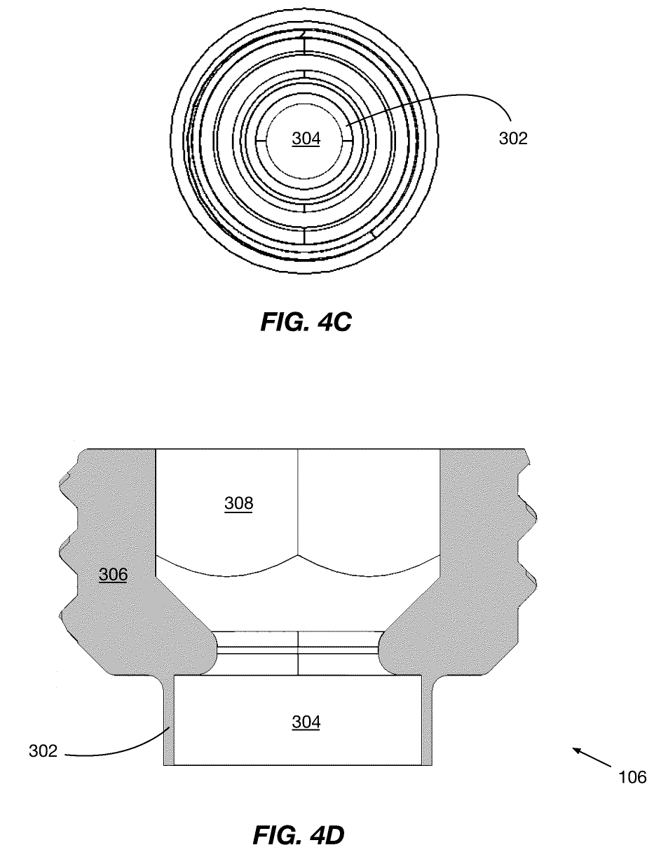

FIGS. 4A-4C are side, top, and bottom views, respectively, of an implementation of a sample collector 106; and FIG. 4D is a cross-sectional view of the implementation of a sample collector of FIGS. 4A-4C. As discussed above, in many implementations, a top portion 306 of the collector may be threaded to be removably inserted into a body 100 of a sampler. Bottom portion 302 may have sharp edges and have a profile corresponding to a punch 122 in the body of the sampler.

As shown in FIGS. 4D and 3B, in many implementations, collector 106 may include a passage between collection chamber 304 and socket 308. This may allow for removal of samples from the collector 106 by inserting a probe or shaft through the passage, pushing the samples out through lower portion 302. The passage may also aid users in placement of the sampler, as they may view the plant tissue placed within the chamber of the sampler through the hole in the collector 106 prior to pressing the depressible portion 108 and punching out the tissue sample.

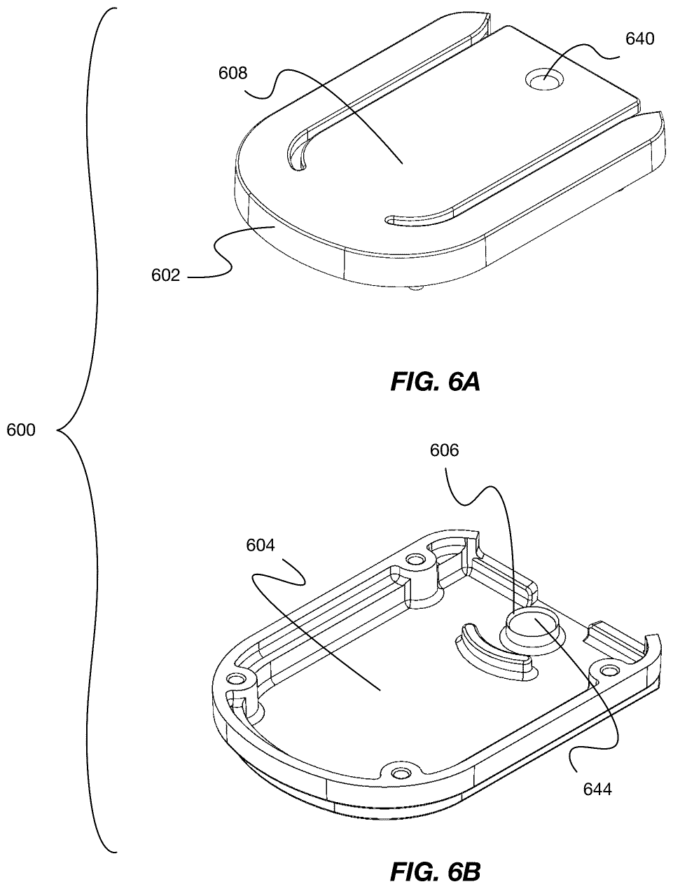

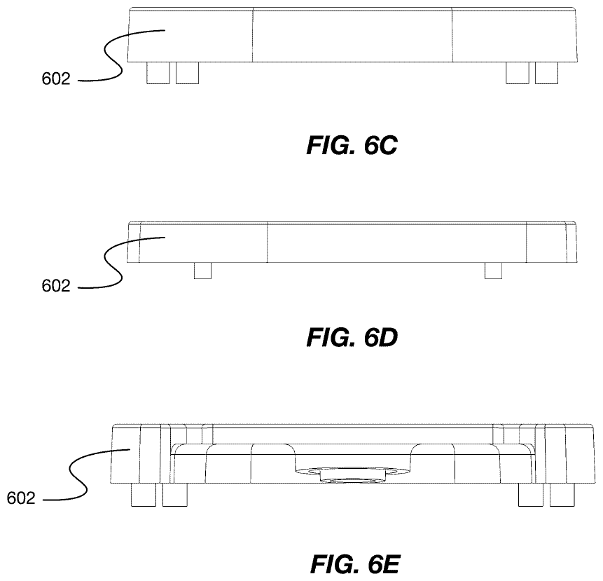

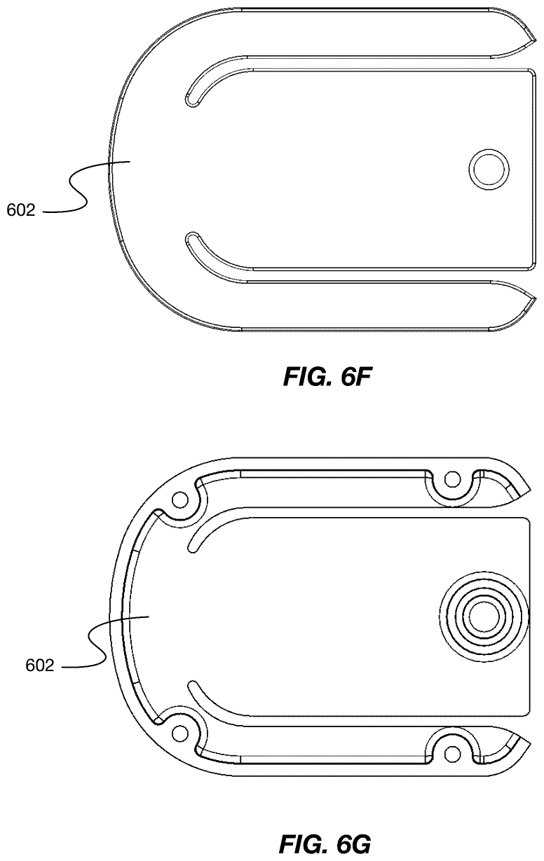

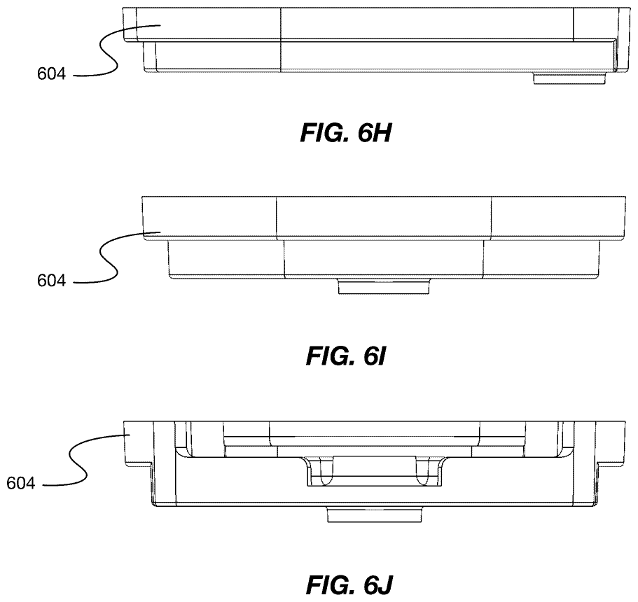

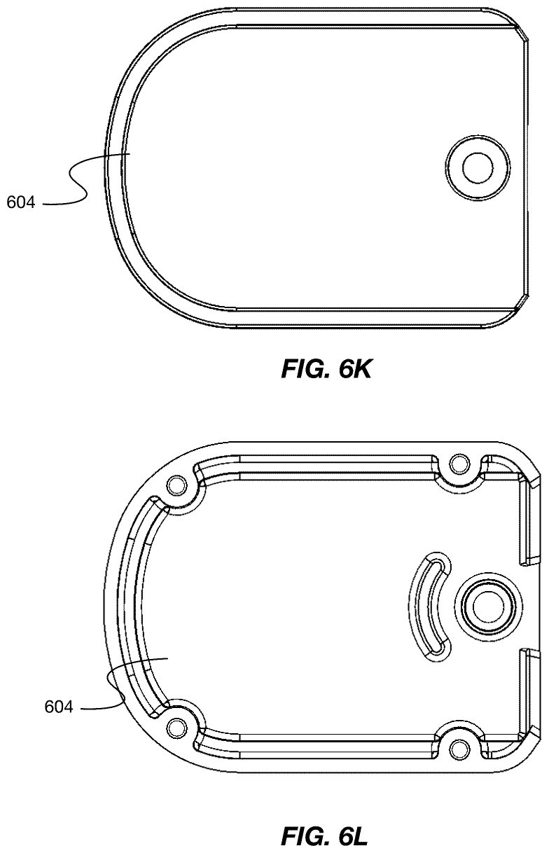

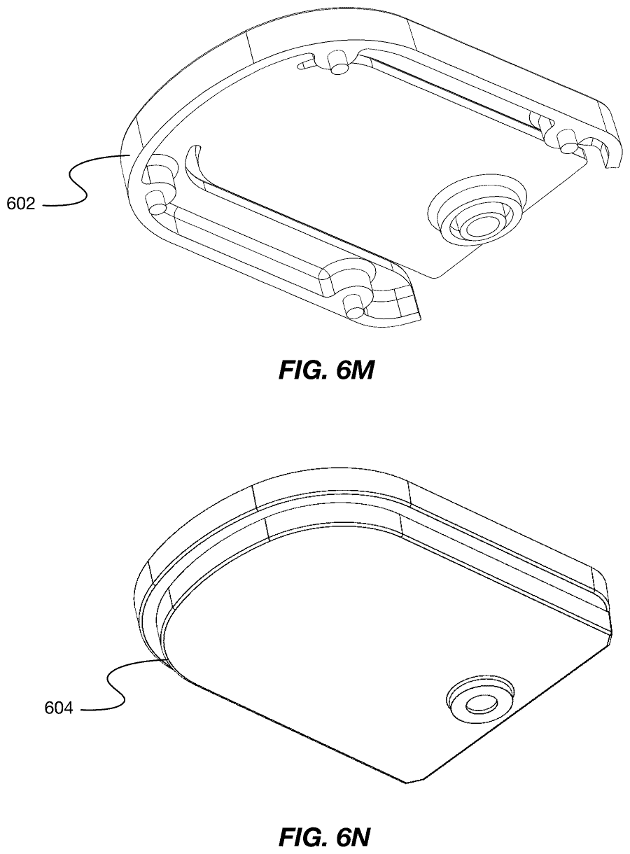

FIGS. 6A and 6B are perspective views of portions of another implementation of a plant tissue sampler, similar in function to sampler 10 discussed above. As shown, the plant tissue sampler may comprise a first portion or top portion 602, similar to top portion 102; and a second portion or bottom portion 604, similar to bottom portion 104. The combined portions may be referred to as a body 600, similar to body 100. The body 600 may include a depressible region 608, similar to region 108, which may be flexible joined to a remainder of the body and/or top portion 602 via a hinge or similar joint as shown. For example, the depressible region 608 may comprise a section of the top separated by two grooves or channels and joined to the remainder of the top portion by a flexible segment. The sampler may also include a collector 606, similar to collector 106 discussed above.

Still referring to FIGS. 6A and 6B, the collector 606 may be integral with the bottom portion 604 of the sampler. In the illustrated embodiment, the punch is part of the upper portion 604 of the sampler and the die is part of the collector 606 in the lower portion 604, although in other embodiments these features may be reversed. When the upper portion or punch is brought together into the collector or die, a collector chamber is formed that may capture and house the cut sample. The collector chamber may have a hollow core or opening that extends from a top opening 642 to a bottom opening 644, making a clear path through the entire clip. The collector chamber may have any suitable profile, such as cylindrical, prismatic (e.g. hexagonal prism, rectangular prism, etc.), conic or tapered, or any other such profile.

FIGS. 6C-6E are side, rear, and front plan views of the portion of a plant tissue sampler of FIG. 6A; and FIGS. 6F and 6G are top and bottom plan views of the portion of a plant tissue sampler of FIG. 6A, according to some implementations. Similarly, FIGS. 6H-6I are side, rear, and front plan views of the portion of a plant tissue sampler of FIG. 6B; and FIGS. 6K and 6L are top and bottom plan views of the portion of a plant tissue sampler of FIG. 6B, according to some implementations. FIG. 6M is a reverse perspective view of the portion of a plant tissue sampler of FIG. 6A, according to some implementations; and FIG. 6N is a reverse perspective view of the portion of a plant tissue sampler of FIG. 6B, according to some implementations.

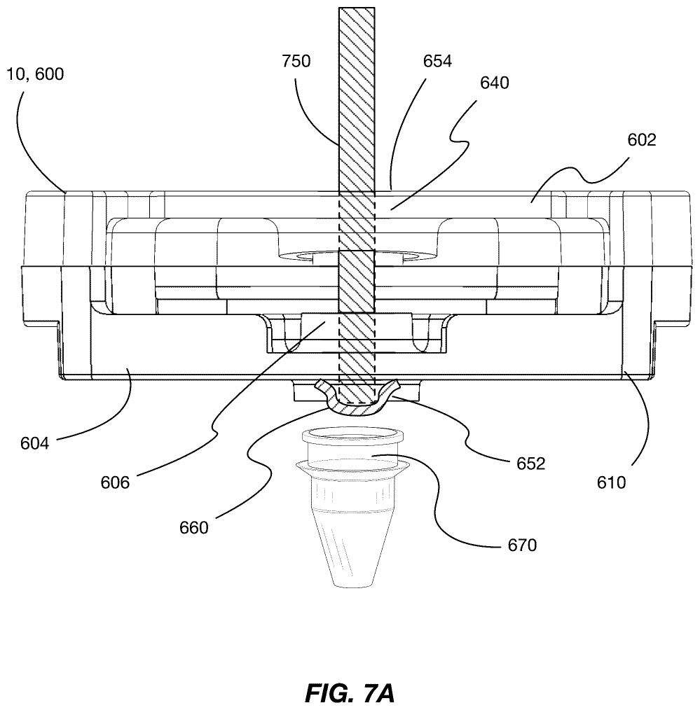

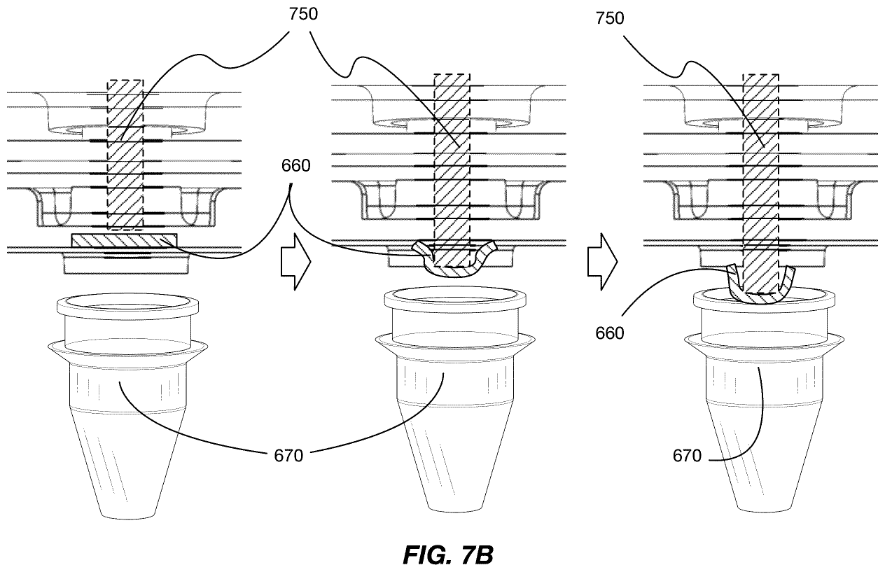

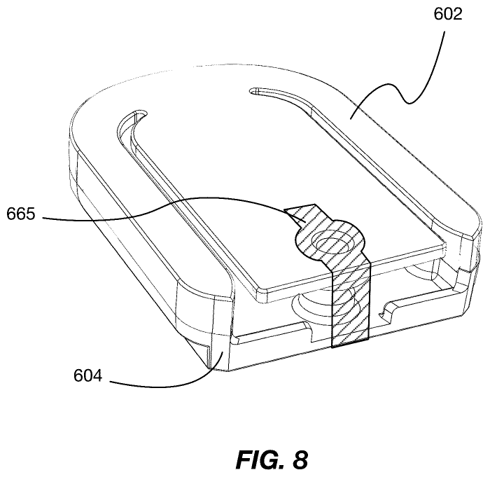

FIG. 7A is a front plan view of the plant tissue sampler of FIG. 6A illustrating extraction of a sample with a probe, according to some implementations, and illustrates how the opening 640 may be approximately concentric with the collector 606. Such implementations may allow for a shaft or probe 750 to be inserted to displace the sample 660 from the collector 606 into a receiving well, tube or other medium 670, positioned below the sampler (some portions of probe 750 are shown in dashed line indicating they are inside or obscured by portions of the sampler). In order to maintain the sample 660 in the collector 606, in some implementations the bottom of the collector may incorporate a ledge 652 surrounding the bottom opening 640, so that the sample may not be removed from the collector 606 unless it is deformed to fit through the bottom opening 644. For example, referring briefly to FIG. 7B, illustrated is a sequence of positions of a probe 750 during extraction of a sample 660 from collector 606. As shown, as the probe is inserted into and through the collector, the sample 660 (shown with diagonal shading) may be deformed to pass through the opening 640 into the receiving medium 670.

Returning to FIG. 7A, the top of the collector 606, may include features on the punch that surrounding the top opening 642 to restrict the sample from being displaced through the top opening 642. In some implementations, the top opening may also include an angled chamfer 654 or lead in to facilitate probe 750 insertion.

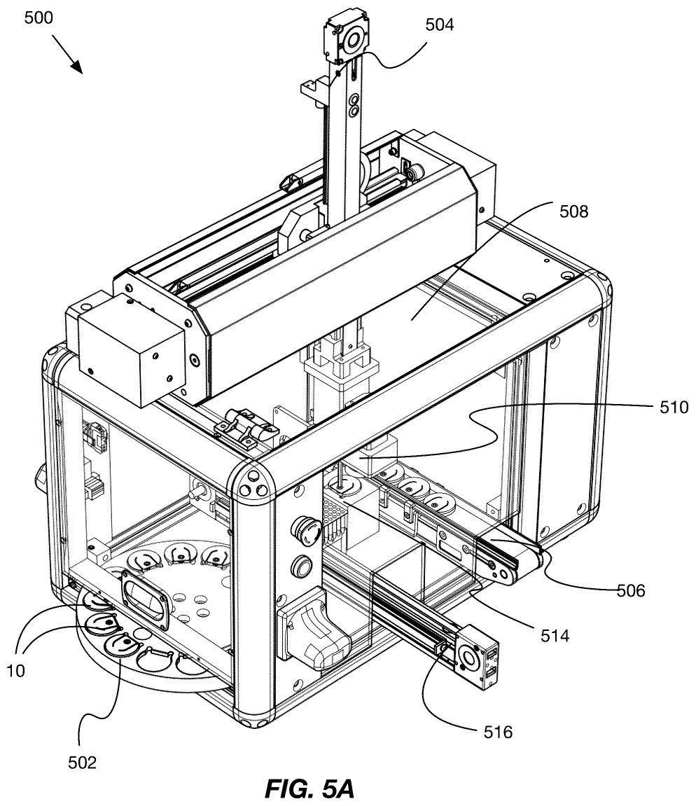

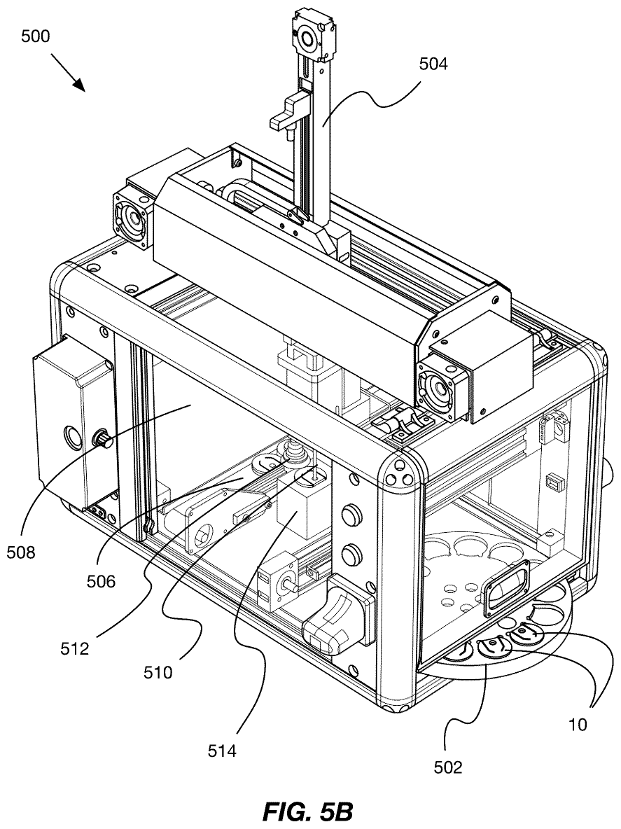

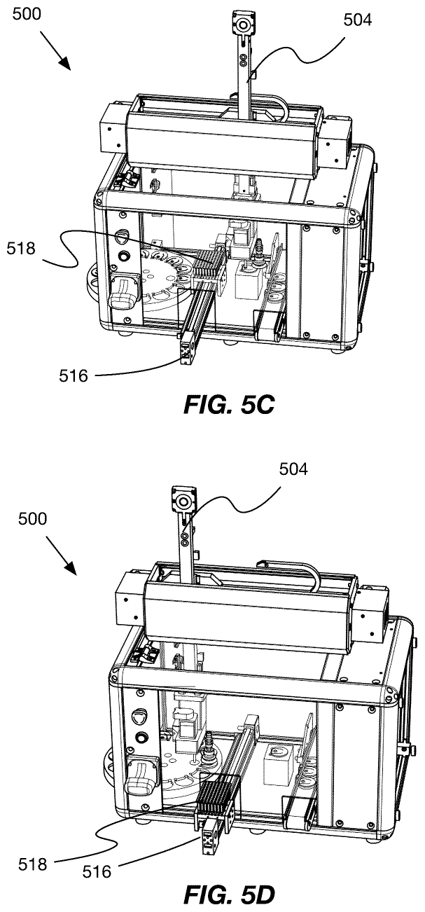

The clip may also incorporate alignment features 610, such as one or more notches, undercuts, protuberances, or other physical features. The alignment features 610 may help to both positionally locate the clips in other devices and to assure that the clips are inserted in the appropriate orientation in other devices. For example, notches 610 can assure that the clips are properly inserted into a carousel fixture 502 (discussed below in connection with FIG. 5A or a similar receiver) rather than in the reversed orientation thereby keeping the opening 640 accessible and aligned with other system features.

In many implementations, once samples are collected, the entire sampler may be sealed (e.g., within a bag, box, or other container) and provided to a lab for analysis. To prevent samples from drying out during transit, in some implementations, a cover may be placed over the opening into a chamber of the sampler (and/or over collector 106, 606). The cover may comprise, for example, a clip or plug (e.g., metal, plastic, silicon, rubber, or any other type and form of material or combination of materials) placed into and/or over or around opening 110 or the body of the sampler. In some implementations, a sealing element or sticker may be placed over an opening to seal the chamber. In some implementations, the cover, sticker, or plug 665 may also prevent samples from falling out due to vibration or other forces during transit.

For example, FIG. 8 is an illustration of an embodiment of a plant tissue sampler showing a top portion 602 with a sealing element or sticker 665 (shown partially transparent, though the sticker may be opaque or translucent, in various embodiments) affixed over an opening (e.g., opening 640). In the embodiment shown in FIG. 8, a hollow cylindrical core surrounded by a top opening 640 and bottom opening 644 (as shown in FIGS. 6A and 6B), may be sealed by a sealing element 665. The sealing element 665 may comprise one or more pieces. For example, in some implementations, a single covering layer 665 may be of a wrap-around design so that it may simultaneously seal the top opening 640 and bottom opening 644. In other implementations, separate sealing elements or stickers may be utilized to cover each opening. In some implementations, the sealing element 665 may be applied so as to keep the depressible region 108, 608 in the downward or closed position, thereby keeping the punch and die engaged with one another and creating a sealed or somewhat-sealed chamber for the sample being located in the collector 106, 606. Any suitable sort of adhering means may be used to keep the sealing element 665 sealed to the clip body 10, 600. Such adhering means may initially be part of the sealing element 665 and/or the clip body 10, 600. For example, a thin label or sticker material may have a pressure sensitive adhesive on one of its sides, which when pressed against the clip, can maintain an airtight or near airtight seal. Any number of adhering or sealing means materials or methods may be utilized, including adhesives or polymers of any sort, and any variation of geometries may be used.

In a similar implementation, to prevent samples from falling out of the bottom of the collector 106, 606 after sampling, depressible portion 108, 608 of the body may remain depressed such that the collector (and collected samples) is held firmly against the punch (and channel). This may also help reduce moisture loss during transit. To keep depressible portion 108, 608 depressed, in some implementations, an external clip may be placed around the sampler (e.g., a spring clip or binder clip or similar means of applying a compression force to the body and depressible portion 108, 608). In other implementations, depressible portion 108, 608 may include an internal latch (e.g., hook and eye or ridge, or similar features of the depressible portion and support surface or lower portion that are engaged when a depressible portion is depressed). For example, in one such implementation, a hook on the underside of a depressible portion may engage with an eye or similar hole molded in a top face of support surface such that the depressible portion is unable to return to its starting position after depression. During sampling, in some such implementations, the hook and/or eye may be blocked by the leaf material surrounding the sampled portion, such that they are not engaged and the leaf may be removed from the sampler after sampling; when subsequently depressing depressible portion without a leaf inserted in the sampler, the latch may engage to securely hold the previously sampled tissue within the collector.

In many implementations, for customer and/or plant identification, the sampler may include a visible code (e.g., barcode, QR code, serial number, or other such identifier) on a portion of the body, such as the outer surface of lower portion 104 or the upper portion 102. This code may be scanned to identify the sampler, and details about the corresponding plant may be associated with the code (e.g., customer identifier, greenhouse number or location, plant row and position, plant identifier, date or time of sample, etc.). Biological information about the sample (e.g., genotype, phenotype, health or disease information, etc.) may also be associated with the code, allowing for easy retrieval of the biological information given the corresponding plant information. In many implementations, the collector may be automatically removed via a robot or similar automated industrial machine, e.g., by inserting a shaft into socket 308 and unscrewing the collector from the base plate. As discussed above, in many implementations, a probe may push the tissue sample or samples through the collector into a medium for testing (e.g., wells of a PCR plate). The used collector and/or sampler body may be discarded, or may be sterilized and reused in whole or in part.

In other implementations, the sample may be removed from the collector 106, 606 automatically without collector 106, 606 removal from the clip 10, 600 via a robot or similar automated industrial machine, e.g., by inserting a shaft or probe 750 into top opening 742, through the collector chamber 106, 606 and through the bottom opening 644. As discussed above, in many implementations, a probe 750 may push the tissue sample or samples through the collector 106, 606 into a medium for testing (e.g., wells of a PCR plate). The used clip 10, 600 and probe 750 may be discarded, or may be sterilized and reused in whole or in part.

FIG. 5A is a front perspective view of an implementation of an automated sample extractor 500, which may be referred to variously as a robot, an automated extractor or automated extraction system, a sample extractor, a sampling robot, a computer-aided sampler (CAS), an automated sampler, or by any other similar names. Sample extractor 500 may comprise an input 502, which may comprise a carousel (as shown), conveyor belt, hopper, or any other type and form of input for loading one or more plant tissue sampler(s) 10. For example, in the implementation shown, a carousel may be loaded with one or more sampler(s) 10, either in place in extractor 500 or separately and then placed onto a spindle or shaft in extractor 500 (not shown). The carousel or other input 502 may provide and position sampler(s) 10 in place for sample extraction (e.g., by rotating a predetermined amount, advancing a predetermined amount, etc.).

Extractor 500 may comprise an arm 504, which may be variously referred to as an extraction arm, tool arm, tool carrier, waldo, or by other such terms. Arm 504 may include a grasper, suction tube, plunger, probe or other mechanism for extracting a sample from a sampler referred to generally as a manipulator 510. For example, as discussed above, in many implementations, a sampler 10, 600 may include a collector 106, 606. A collector may include a socket 308, which may have a predetermined shape, interior thread, or other such surface to engage with a manipulator 510 of an arm 504. The manipulator 510 may be inserted into a socket 308 of a collector 106, 606 and, in many implementations, rotated to remove the collector 106, 606 from the tissue sampler 10, 600. Once removed, the collector may be placed over a sample receiver 518, 770 (e.g., a well of a PCR plate), and the sampled tissue may be ejected from the collector (e.g., via a puff of air through socket 308 and chamber 304; via a depressed plunger through socket 308 and chamber 304; etc.) and received in the sample receiver 518, 770. Accordingly, friction, vacuum, and/or air pressure may be used to hold samplers 10, 600, sockets 308, and/or collectors 106, 606. For example, in some implementations, the sampler 10, 600 body may be held on a base or anvil (or other similar term) below the manipulator 510 and retained via a clip, vacuum, magnetic attraction, and/or any combination of friction or other forces to allow manipulator 510 to extract the collector 106, 606 and sample.

Once a tissue sample is removed from a collector 106, 606, the empty collector may be discarded, re-inserted in the sampler 10, 600, or otherwise moved. Extractor 500 may also comprise a sampler output 506 for outputting empty samplers and/or collectors 106, 606. Arm 504 may be configured to place the sampler and/or collector on the output after removal of the sampled tissue.

In some implementations, a sampler 10, 600 may include an integral collector 606 that is maintained in the sampler 10, 600 and not removed. That is, the collector may comprise a portion of the body of the sampler, rather than a removable component. In some such implementations, the sampled tissue may be ejected from the collector or sampler, (e.g., via a puff of air; via a depressed plunger 750; etc.) and received in a sample receiver 518, 770.

In some implementations, output 506 may comprise a conveyor belt (as shown), or may comprise a carousel, hopper, bin, shaft, or other output mechanism. Although shown with input 502 at left and output 506 at right, in some implementations of an extractor 500, the input 502 and output 506 may be switched (or placed elsewhere on the machine, as necessary). For example, in one implementation, an input conveyor 506 may receive samplers 10, arm 504 may extract tissue samples, and the empty samplers may be loaded onto an output carousel 502 for sterilization and reuse.

In some implementations, arm 504 may comprise a camera, scanner, barcode reader, NFC reader, or similar input interface for reading or receiving an identifier of a sampler 10, such as a barcode, QR code, alphanumeric code, NFC code, Bluetooth beacon, or other such transmitted or displayed identifier of a sampler. Similarly, identifiers may be present in the sample receiver 518, 670, allowing samples to be tracked from samplers 10, 600 to labware used for extraction, analysis or other processing. The identifier and position of the extracted tissue sample in a sample receiver 518, 670 or PCR well or similar tray may be stored in a database, flat file, array, or other data structure. For example, a PCR tray may have a tray identifier, and each well in the tray may be associated with a separate tissue sample identifier, allowing for easy management of samples.

In other implementations, a camera, scanner, barcode reader, NFC reader, or similar input interface for reading or receiving an identifier of a sampler 10, 600 and/or sample receiver 518, 670 may be located within the extractor 510 off the arm 504.

In many implementations, extractor 500 may include a sealed or semi-sealed chamber 508. This chamber may have temperature and/or humidity control (e.g., via integrated fans, heaters, chillers, humidifiers, dehumidifiers, etc.) in some implementations. In some implementations, the chamber may have reduced airflow to prevent sample contamination. In some implementations, the chamber may be filled with an inert gas to prevent oxidation of samples.

FIG. 5B illustrates a reverse view of the implementation of an extractor 500 of FIG. 5A. In other implementations, different components may be utilized, or the components shown may have different placement. As shown in FIG. 5B, an extractor 500 may comprise a second manipulator 512, which may take the form of a vacuum nozzle or suction cup as shown, or any other type and form of manipulator (, grasper, claw, electromagnet, etc.). In many implementations, both manipulator 510 and second manipulator 512 may be on the same arm 504 (e.g., on a rotating tool holder, etc.). The second manipulator 512 may be configured to collect a sampler 10, 600 from the carousel or other input, position the sampler 10, 600 for sample extraction by manipulator 510. For example, the second manipulator may comprise a suction nozzle sized to attach, via a vacuum, to a sampler 10, 600 and reposition the sampler as needed. The second manipulator 512 may move a sampler 10, 600 to a base or anvil 514 below manipulator 510 for extraction of a collector 106, 606. Such a base or anvil 514 may hold the sampler 10, 600 via a vacuum, physical latch, electromagnets, or any other combination of these or other mechanisms. The second manipulator 512 may also move samplers 10, 600 to the output conveyor or bin(s) after sample extraction.

In another implementation, the second manipulator 512 may be configured for liquid handling, such as capable of aspirating and dispensing liquids. For example, the second manipulator may comprise a pipetting system with either washable or disposable pipette tips. The second manipulator 512 may transfer liquids into or out of sample receivers 518, 770 or other labware. The second manipulator configured as a liquid handler may perform any number of liquid transfer operations, thereby making the extractor 500 a highly flexible automated system that may be utilized for any number of laboratory tasks. The second manipulator 512 may also move sample receiver 518, 770 or other labware to the output conveyor or bin(s) after sample extraction.

In some implementations, the sample receiver 518, 770 may be held by a receiver arm 516, which may comprise a conveyor, XY positioning table or other mechanism for loading, positioning, and removing sample receivers 518, 770. For example, referring to FIG. 5C, a sample receiver 518, 770 such as a PCR tray may be supported and held in position for sample extraction from samplers 10, 600 and collectors 106, 606. Once extraction is complete, the receiver 518, 770 may be automatically repositioned by the receiver arm 516 to where it may be manually removed from the extractor 500 (or automatically removed by a second machine or arm, loaded into an adjacent machine for processing or analysis, etc.), as shown in the example of FIG. 5D.

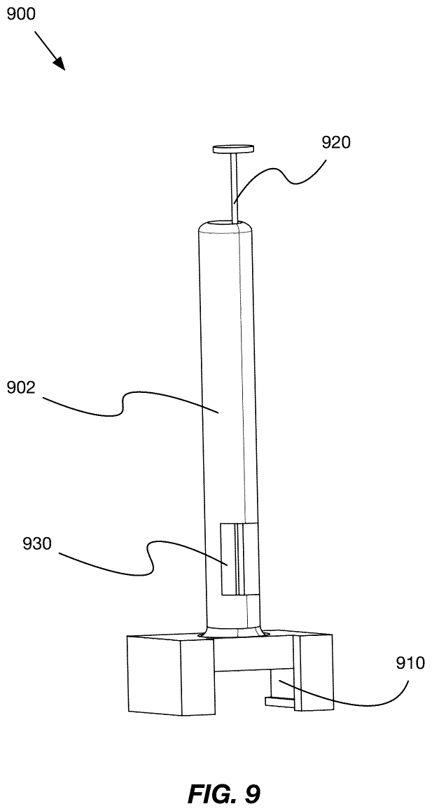

In yet another implementation shown in FIG. 9, the sample may be removed from the collector 106, 606 via an extraction tool 900. In this implementation, the extraction tool allows operators to perform multiple functions with a single hand including: hold the sampler, align an actuatable extraction probe 750 with the top opening 642 and hollow cylindrical core of the sampler, align the bottom opening 644 or the sampler over a sample receiver 518, 670, actuate the extraction probe 750 and push the sample into the sample receiver 518, 670. In some implementations, the extraction tool includes a plunger 920 that moves vertically within the extraction tool 900 and articulates the end of a shaft or probe 930. To reduce the possibility of cross contamination, the shaft or probe 930 may be disposable or removable to be decontaminated. The extraction tool may also include a clip interface 910, which can locate the top opening 642 of the clip directly under the centerline of the plunger 920 or probe 930. The clip interface may engage with alignment features 610 on the clip to align it more precisely in the extraction tool 900. As the operator depresses the plunger 920, the shaft or probe 930 enters the sampler or clip through the collector chamber 106, 606 and pushes the sample 660 through the bottom opening 644 into an awaiting well, tube or other medium 670, which may receive the sample 660. The used clip and probe 930 may be discarded, or may be sterilized and reused in whole or in part. In some implementations, the remainder of the extraction tool (with the probe removed or replaced) 900 may be reused without decontamination.

Accordingly, the systems and methods discussed herein provide for easy and efficient plant tissue sample collection with reduced risk of contamination and/or user errors. The tissue samples may be used in any sort of biological testing, including pathogen testing, sex testing, chemotype, testing for genetic markers, genomic sequencing, phenotype identification, or any other process.

What is claimed:

1. A system for sampling biological materials, comprising:
a sampler device comprising:
a first portion comprising a first cutting surface,
a second portion comprising a second cutting surface configured to engage with the first cutting surface, and
a collector chamber positioned in the first portion or second portion, configured to receive a biological sample after engagement of the first cutting surface and second cutting surface.

2. The system of claim 1, wherein the collector chamber is part of the second portion.

3. The system of claim 2, wherein the collector chamber is bounded by the first cutting surface and second cutting surface, after engagement.

4. The system of claim 1, wherein at least one of the first cutting surface and the second cutting surface has a substantially cylindrical profile with a hollow core.

5. The system of claim 4, wherein at least one of the first cutting surface and the second cutting surface comprises an interior protrusion configured to prevent passage of a sample through the hollow core.

6. The system of claim 5, wherein the interior protrusion comprises a ledge.

7. The system of claim 4, further comprising an insertable probe sized to fit through the hollow core to push a collected sample out of the collector chamber.

8. The system of claim 7, wherein an opening to the hollow core in one of the first portion and the second portion comprises an angled chamfer to facilitate said probe insertion.

9. The system of claim 4, further comprising an extractor tool comprising:
a sampler device retainer; and
an actuatable extraction probe sized to fit through the hollow core to push a collected sample out of the collector chamber into a sample receiver.

10. The system of claim 9, further comprising an automated extraction system comprising:
a sampler device retainer; and
a probe for extracting samples from a sampler device positioned in the sampler device retainer.

11. The system of claim 10, wherein the automated extraction system further comprises a second manipulator that includes a liquid handling system.

12. The system of claim 11, wherein the automated extraction system further comprises a receiver arm to position at least one sampler device under the probe.

13. The system of claim 1, wherein during engagement, the second cutting surface and the first cutting surface form a substantially gas-tight seal.

14. The system of claim 1, wherein the collector chamber is removable.

15. The system of claim 1, wherein at least one of the first portion and the second portion comprises an opening into an interior of the device, and further comprising a sealing element configured for placement over the opening.

16. The system of claim 15, wherein the sealing element is further configured to maintain engagement between the first cutting surface and the second cutting surface.

17. A method for sampling biological samples, comprising:
positioning a sampler device around a portion of a plant or other organism;
actuating the sampler device to cut a sample from the portion of the plant or other organism, the cut sample captured in a collector chamber within the sampler device; and
transferring the cut sample from the collector chamber into a sample receiver.

18. The method of claim 17, further comprising, prior to transferring the cut sample from the collector chamber into the sample receiver:
positioning the sampler device around a second portion of the plant or other organism; and
actuating the sampler device to cut a second sample from the second portion of the plant or other organism, the second cut sample captured in the collector chamber along with the first cut sample.

19. The method of claim 17, wherein transferring the cut sample from the collector chamber into the sample receiver further comprises:
positioning the sampler device within a retainer of an extractor tool; and
extending a probe of the extractor tool into a hollow core of the sampler device to push the cut sample into the sample receiver.

20. The method of claim 17, wherein transferring the cut sample from the collector chamber into the sample receiver further comprises positioning the sampler device in an input retainer of an automated extractor device, the automated extractor device comprising a probe for extracting samples from the sampler device.
